(19) United States
(12) Patent Application Publication
(10) Pub. No.: US 2008/0018798 A1
(43) Pub. Date: Jan. 24, 2008

(54) Multi-Color Display Device and Driving Method Thereof

(76) Inventors: Kyong-Tae Park, Uijeongbu-si (KR); Beohm-Rock Choi, Seoul (KR); Sung-Soo Lee, Suwon-si (KR); Young-Rok Song, Yongin-si (KR); Ji-Hye Choi, Yongin-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/781,102

(22) Filed: Jul. 20, 2007

(30) Foreign Application Priority Data
Jul. 24, 2006 (KR) 10-2006-0069192

(51) Int. Cl. H04N 9/73

(52) U.S. Cl. 348/655

(57) ABSTRACT

A display device and a driving method thereof are provided. The display device includes a plurality of pixels that displays a first color, a second color, a third color, and a white color; a signal processor that generates a white color output image signal based on three input image signals displaying the first to third colors, generates a white color temperature correcting constant based on the white color output image signal, and generates first color, second color, and third color output image signals that correct the first color, second color, and third color input image signals based on the white color temperature correcting constant; and a data driver that converts the output image signal to a data voltage and supplies the data voltage to the pixel to allow the pixel to display an image. Therefore, a color temperature of white light that four color pixels emit can be adjusted to a target color temperature by adjusting an image signal value related to the remaining three color pixels according to luminance of white light that a white pixel emits.

### CROSS-REFERENCE TO RELATED APPLICATION

This application claims priority to and the benefit of Korean Patent Application No. 10-2006-0069192 filed in the Korean Intellectual Property Office on Jul. 24, 2006, the entire contents of which are incorporated herein by reference.

### BACKGROUND OF THE INVENTION

(a) Field of the Invention

The present invention relates to a display device and a driving method thereof, and more particularly, to a multi-color organic light emitting diode (OLED) display.

(b) Description of the Related Art

Recently, a flat panel display that can replace a cathode ray tube (CRT) has been actively researched. The flat panel display includes a plurality of pixels that displays three primary colors, arranged in a matrix form. One color is determined by combining three colors emitting from three pixels, and the flat panel display displays a desired image by appropriately controlling luminance of each pixel.

However, when an image is displayed with only three primary color pixels, light efficiency may deteriorate. Particularly, in an OLED display, light emitting efficiency of an emission layer may further deteriorate as an emission layer material of an OLED changes according to color. Accordingly, a method of adding a white pixel emitting white light in addition to three primary color pixels has been suggested.

### SUMMARY OF THE INVENTION

An exemplary embodiment provides a display device including: a plurality of pixels that displays a first color, a second color, a third color, and a white color; a signal processor that generates a white color output image signal based on three input image signals displaying the first to third colors, generates a white color temperature constant based on the white color output image signal, and generates first color, second color, and third color output image signals that correct first color, second color, and third color input image signals based on the white color temperature constant; and a data driver that converts the output image signal to a data voltage and supplies the data voltage to a pixel to allow the pixel to display an image.

The white color temperature constant may have a value such that white light that is generated by combining the first to third pixels with the white pixel may satisfy a target white color temperature.

The white color temperature constant may have a different value depending on a gray of the white output image signal.

The white color temperature constant may separately have a value corresponding to the first color, the second color, and the third color.

The white color temperature constant may be determined in luminance space.

The signal processor may generate first color, second color, and third color luminance signals by performing gamma conversion of each of the first color, second color, and third color image signals, generate first color, second color, and third color corrected luminance signals by calculating each of the first color, second color, and third color luminance signals with the white color temperature constant, and generate first to third color output image signals by performing de-gamma conversion of the first color, second color, and third color corrected luminance signals.

The signal processor may generate a white luminance signal from the first to third color luminance signals and generate a white output image signal by performing de-gamma conversion of the white luminance signal.

The white luminance signal may be equal to a smallest luminance signal among the first to third color luminance signals, and the first to third color corrected luminance signals may be obtained by subtracting the white luminance signal from the first to third color luminance signals and then calculating the signals with the white color temperature constant.

The white output image signal may be equal to a smallest input image signal among the first to third color input image signals.

The signal processor may include a lookup table that stores a white color temperature constant of the first to third colors as a function of a gray luminance that the white output image signal may have.

The signal processor may perform a shift calculation so that the bit number of the white color temperature constants of the first to third colors that are stored in the lookup table may be equal to that of the luminance signal.

The white color temperature constant may be a linear function of luminance of the white output image signal.

The signal processor may obtain a white color temperature constant of the first to third colors by multiplying luminance of the white output image signal by a different coefficient.

The signal processor may perform de-gamma conversion by adjusting the bit number of the corrected luminance signal to a predetermined bit number.

The first to third colors may be three primary colors.

The pixel may include an organic light emitting device.

Another embodiment of the present invention provides a driving method of a display device including: receiving three input image signals that display each of three primary colors; generating three luminance signals and a white output image signal based on three input image signals; generating three white color temperature constants based the white output image signal; generating three corrected luminance signals by calculating each luminance signal with the white color temperature constant; and generating three output image signals by performing de-gamma conversion of three corrected luminance signals.

The driving method may further include converting four output image signals including the white output image signal to a data voltage and applying the data voltage to four pixels of the display device, wherein a white color of the four pixels may satisfy a target white color temperature when the three input image signals display a white color.

The white color temperature constant may have luminance of a different magnitude depending on the white color output image signal.

### BRIEF DESCRIPTION OF THE DRAWINGS

FIG. 1 is a block diagram of an OLED display according to an exemplary embodiment of the present invention.

FIG. 2 is an equivalent circuit diagram of one pixel of an OLED display according to an exemplary embodiment.

FIG. 3 is a top plan view illustrating a plurality of pixels of an OLED display according to an exemplary embodiment.

FIG. 4 is a graph illustrating a color coordinate.

FIG. 5 is a block diagram of a signal processor according to an exemplary embodiment.

FIG. 6 is a block diagram of a signal processor according to another exemplary embodiment.

FIG. 7 is a block diagram of a signal processor according to still another exemplary embodiment.

### DETAILED DESCRIPTION OF THE EMBODIMENTS

An exemplary embodiment of the present disclosure will hereinafter be described in detail with reference to the accompanying drawings.

A four color display device receives an input image signal for three primary color pixels, for example red, green, and blue color pixels, to generate output image signals for red, green, blue, and white color pixels.

Alternatively, the four color display device emits white light depending on only a white pixel, where a color temperature of the white pixel is determined by emission layer materials and manufacturing processes. The actual color temperature of the white pixel may be different from a preferred target color temperature of white light.

The present invention has been made in an effort to provide a four color display device having advantages of correcting the color temperature of white light to a target color temperature.

The present invention will be described more fully hereinafter with reference to the accompanying drawings, in which exemplary embodiments of the invention are shown.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

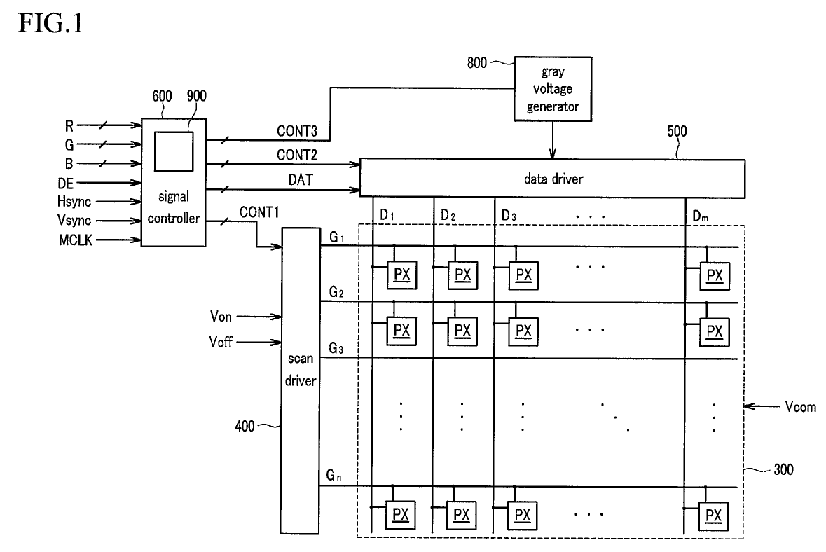

Now, an OLED display according to an exemplary embodiment as an example of a display device will be described in detail with reference to FIGS. 1 to 3.

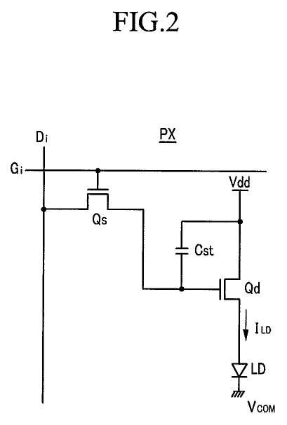

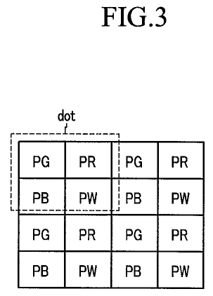

FIG. 1 is a block diagram of an OLED display according to an exemplary embodiment, FIG. 2 is an equivalent circuit diagram of one pixel of an OLED display according to an exemplary embodiment, and FIG. 3 is a view illustrating a pixel arrangement of an OLED display according to an exemplary embodiment.

Referring to FIG. 1, the OLED display includes a display panel 300, a scan driver 400 and a data driver 500 that are connected to the display panel 300, a gray voltage generator 800 that is connected to the data driver 500, and a signal controller 600 that controls them.

The display panel 300 includes a plurality of signal lines G₁-Gₙ and D₁-Dₘ, a plurality of voltage lines (not shown), and a plurality of pixels PX that are connected to them and that are arranged in approximately a matrix form from an equivalent circuit view.

The signal lines G₁-Gₙ and D₁-Dₘ include a plurality of scanning lines G₁-Gₙ that transfer a scanning signal and data lines D₁-Dₘ that transfer a data signal. The scanning lines G₁-Gₙ extend in approximately a row direction and are substantially parallel to each other and are separated from each other. The data lines D₁-Dₘ extend in approximately a column direction and are substantially parallel to each other. Each voltage line (not shown) transfers a driving voltage Vdd and so on.

Referring to FIG. 2, one pixel PX of the OLED according to an exemplary embodiment, for example a pixel PX that is connected to an i-th (i=1, 2, n) scanning line Gᵢ and a j-th (j=1, 2, m) data line Dⱼ, includes an organic light emitting device LD, a driving transistor Qd, a capacitor Cst, and a switching transistor Qs.

The switching transistor Qs as a three terminal element has a control terminal, an input terminal, and an output terminal. The control terminal is connected to the scanning line Gᵢ, the input terminal is connected to the data line Dⱼ, and the output terminal is connected to a control terminal of the driving transistor Qd. The switching transistor Qs transfers a data voltage in response to a scanning signal that is applied through the scanning line Gᵢ.

The driving transistor Qd as a three terminal element also has a control terminal, an input terminal, and an output terminal. The control terminal is connected to the switching transistor Qs, the input terminal is connected to a driving voltage Vdd, and the output terminal is connected to the organic light emitting device LD. The driving transistor Qd allows an output current I_{LD} having a different magnitude to flow according to a voltage that is applied between the control terminal and the output terminal.

The capacitor Cst is connected between the control terminal and the input terminal of the driving transistor Qd. The capacitor Cst stores a data voltage that is applied to the control terminal of the driving transistor Qd through the switching transistor Qs, and sustains the voltage even after the switching transistor Qs is turned off.

The organic light emitting device LD may be an OLED, and it has an anode that is connected to the output terminal of the driving transistor Qd and a cathode that is connected to a common voltage Vcom. The organic light emitting device LD emits light with a different intensity according to an output current I_{LD}, thereby displaying an image. The organic light emitting device LD emits one light among the primary colors and white. An example of a set of the primary colors includes red, green, and blue colors, and a desired color is displayed with the spatial sum of the primary colors.

If white light is added to the synthesized light, the luminance increases.

Alternatively, the organic light emitting device LD of all pixels PX can emit white color light. In this case, some pixels PX may further include a color filter (not shown) that changes white light emitting from the organic light emitting device LD to a primary color light.

Referring to FIG. 3, pixels PX for emitting red, green, blue, and white light, i.e., a red pixel PR, a green pixel PG, a blue pixel PB, and a white pixel PW, are arranged in 2×2 matrix form, i.e., as a pixel set. If the pixel set that is arranged in this way is referred to as a “dot,” the OLED display has a structure in which the dots are repeatedly disposed in a row direction and a column direction.

In each dot, the red pixel PR and the blue pixel PB are opposite to each other in a diagonal direction, and the green pixel PG and the white pixel PW are opposite to each other in a diagonal direction. When the green pixel PG and the white pixel PW are opposite to each other in a diagonal direction, color characteristics of the OLED display are best.

However, the four color pixels PR, PG, PB, and PW may have a stripe arrangement and or other layout arrangement in addition to the checkered arrangement of FIG. 3. Referring back to FIG. 2, the switching transistor Qs and the driving transistor Qd are n-channel metal oxide semiconductor field effect transistors (FETs) that are made of amorphous silicon or polysilicon. However, at least one of the transistors Qs and Qd may be a p-channel MOSFET. Furthermore, the connection relationship of the transistors Qs and Qd, the capacitor Cst, and the OLED LD may be changed.

Referring again to FIG. 1, the scan driver 400 is connected to scanning lines G₁-Gₙ of the display panel 300 to apply a scanning signal consisting of a combination of a high voltage Von that can turn on the switching transistor Qs and a low voltage Voff that can turn off the switching transistor Qs to each of the scanning lines G₁-Gₙ.

The data driver 500 is connected to the data lines D₁-Dₘ of the display panel 300 to apply a data voltage to the data lines D₁-Dₘ for displaying an image on the display panel 300.

The gray voltage generator 800 generates a plurality of gray voltage sets to output to the data driver 500. The gray voltage set may be different for each color, depending on factors such as light emitting efficiency and lifetime of the light emitting layer material.

The signal controller 600 controls operation of the scan driver 400, the data driver 500, and the gray voltage generator 800.

Further, the signal controller 600 includes a signal processor 900 that generates four color output image signals R′, G′, B′, and W′ from three color input image signals R, G, and B. The signal processor 900 will be described in detail later.

Each driving apparatus 400, 500, 600, and 800 may be directly mounted on the display panel 300 in at least one IC chip form, be mounted on a flexible printed circuit film (not shown) to attach to the display panel 300 in a tape carrier package (TCP) form, or be mounted on a separate printed circuit board (PCB) (not shown). Alternatively, the driving apparatus 400, 500, 600, and 800 along with the signal line G₁-Gₙ and D₁-Dₘ and the thin film transistor switching element Qs and Qd may be integrated with the display panel 300. Further, the driving apparatus 400, 500, 600, and 800 may be integrated in a single chip, and in this case at least one of them or at least one circuit element forming them may be provided external to the single chip.

An operation of the OLED display will now be described. The signal controller 600 receives three color input image signals R, G, and B from an external graphics controller (not shown), and an input control signal that controls the display thereof. The input image signals R, G, and B are digital signals having a value of gray level corresponding to the luminance of each pixel PX based on three colors, and the number of grays that the signals can have is, for example, 1024 (=2¹⁰), 256 (=2⁸), or 64 (=2⁶). Luminance that each gray level displays is given by a gamma curve of the display device, and to convert the input image signals R, G, and B or the gray level to luminance is referred to as “gamma conversion.”

The input control signal includes, for example, a vertical synchronization signal Vsync, a horizontal synchronizing signal Hsync, a main clock signal MCLK, and a data enable signal DE.

The signal processor 900 extracts a white color image signal from three color input image signals R, G, and B, corrects the input image signals R, G, and B, and then appropriately processes the signals to correspond to an operating condition of the display panel 300, thereby generating red, green, blue, and white color output image signals R′, G′, B′, and W′.

Further, after generating a scan control signal CONT1, a data control signal CONT2, a gray control signal CONT3, the signal controller 600 sends the scan control signal CONT1 to the scan driver 400 and sends the data control signal CONT2 and the processed output image signals R′, G′, B′, and W′ (i.e., DAT) to the data driver 500.

The scan control signal CONT1 includes a scanning start signal STV that instructs the start of scanning and at least one clock signal that controls an output period of a high voltage Von. The scan control signal CONT1 may further include an output enable signal OE that limits a sustain time of a high voltage Von.

The data control signal CONT2 includes a horizontal synchronization start signal STH that controls the start of transferring digital output image signals R′, G′, B′, and W′ to one row of pixels PX, and a load signal LOAD and a data clock signal HCLK that apply an analog data voltage to the data lines D₁-Dₘ.

According to the data control signal CONT2 from the signal controller 600, the data driver 500 receives four color output image signals R′, G′, B′, and W′ and converts the signals to an analog voltage.

The scan driver 400 converts a scanning signal that is applied to the scanning lines G₁-Gₙ to a high voltage Von according to the scan control signal CONT1 that is supplied from the signal controller 600.

Accordingly, the switching transistor Qs of the corresponding pixel row is turned on and the driving transistor Qd receives the corresponding data voltage through the turned-on switching transistor Qs. Each driving transistor Qd outputs a driving current I_{LD} corresponding to the applied data voltage to the organic light emitting device LD. Accordingly, the organic light emitting device LD emits light of a magnitude corresponding to the driving current I_{LD}.

By repeating the process with a unit of one horizontal period (referred to as “1H”, the same as one period of a horizontal synchronizing signal Hsync and a data enable signal DE), a high voltage Von is sequentially applied to all scanning lines G₁-Gₙ and a data voltage is applied to all pixels PX, whereby an image of one frame is displayed.

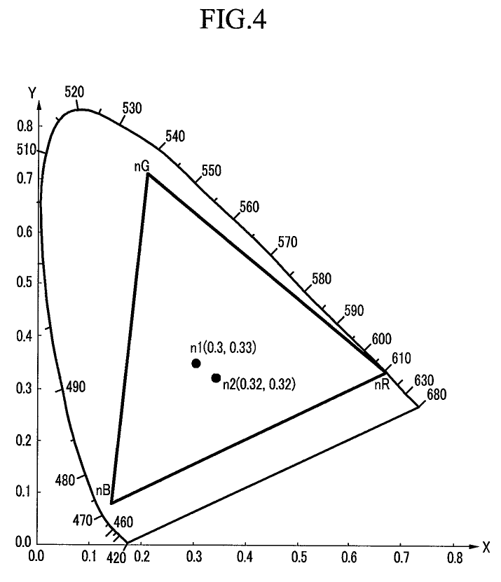

A signal processor 900 will now be described in detail with reference to FIGS. 4 to 7.

FIG. 4 is a graph illustrating a color coordinate. The color coordinate of FIG. 4 is shown in a calorimetric method that was determined by the International Commission on Illumination (CIE: Commission Internationale de l'Eclairage), and consists of x and y coordinates that are formed based on a value that is measured by a spectrophotometer.

The x and y coordinates display a color temperature, and the color temperature is related to the color and saturation, but not to luminance.

The curved line of a horseshoe shape shown in the color coordinate is called the spectral locus and corresponds to monochromatic light, with each wavelength indicated in nanometers. The straight line is called the purple line, and connects a saturated violet color to a saturated red color. Colors on this line have no monochromatic counterpart (i.e., they are mixtures of colors). All colors are included within the boarder of the curved line and the straight purple line. Less saturated colors are closer to the center of the figure, with white light at the center.

The triangle that is displayed within a curved line of a horseshoe shape defines a color range that a display device including three color pixels is capable of displaying, and vertices nR, nG, and nB of the triangle display a composite color of red, green, and blue colors.

In this case, a color temperature of a white color is determined according to a material and a process condition of the organic light emitting device LD associated with a white pixel PW. For example, in FIG. 4, the color temperature nk(x,y) of the white color that the organic light emitting device LD of the white pixel PW displays may be n1 (0.3, 0.33) and this may be different from n2 (0.32, 0.32), which is a target color temperature of the white color of the display device.

When the signal processor 900 generates four color output image signals R′, G′, B′, and W′, a color temperature point of the white color that the pixel PX displays can be changed to a target color temperature point by detecting a difference between a target color temperature of the white color and an actual color temperature thereof.

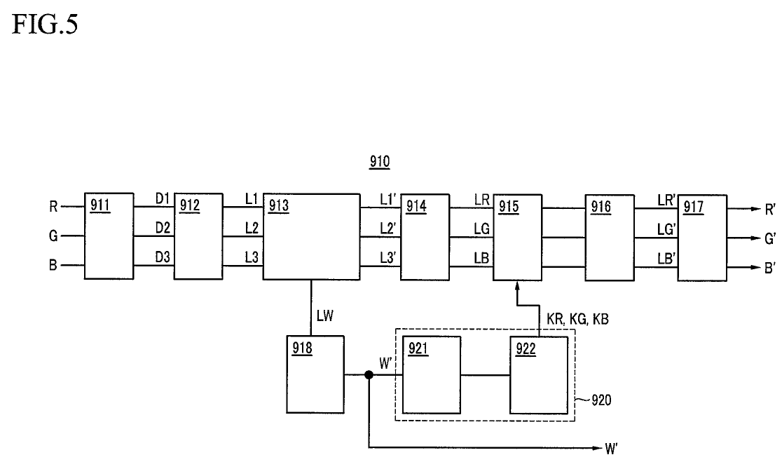

Referring to FIG. 5, a signal processor 910 for correcting a color temperature of the white color will be described in detail.

FIG. 5 is a block diagram of a signal processor according to an exemplary embodiment, which can be used as the signal processor 900 of FIG. 1.

The signal processor 910 receives sets of three color input image signals R, G, and B from the outside to generate one white output image signal W′ and three color output image signals R′, G′, and B′ from each set of three color input image signals R, G, and B. The signal processor 910 includes a first signal ordering unit 911, a gamma converter 912, a calculator 913, a second signal ordering unit 914, a color temperature correction unit 915, a three-color de-gamma converter 917, a white de-gamma converter 918, and a color temperature constant calculator 920.

The first signal ordering unit 911 receives sets of three color input image signals R, G, and B from the outside to arrange three input image signals R, G, and B belonging to each set of three color input image signals R, G, and B in order according to a gray level thereof. Each of the input image signals R, G, and B can be arranged in the order of highest gray level first.

When the signals are arranged in this way, the input image signals R, G, and B are ordered having a highest gray level first, called a first signal D1, followed by a second signal D2, and a third signal D3 in order, and gray levels of the first, second, and third signals D1, D2, and D3 are called a first, second, and third gray level. Therefore, signals R, G, and B become ordered by brightness (i.e., gray level).

The gamma converter 912 performs gamma conversion of the signals D1, D2, and D3 to generate a first luminance signal L1, a second luminance signal L2, and a third luminance signal L3 having the first, second, and third luminance corresponding to the first, second, and third gray levels of D1, D2, and D3, respectively.

The calculator 913 generates a white luminance signal LW based on the three luminance signals L1, L2, and L3, and converts the luminance signals L1, L2, and L3 to first, second and third corrected luminance signals L1′, L2′, and L3′ based on the white luminance signal LW. Calculator 913 may generate the white luminance signal LW and corrected luminance signals L1′, L2′, and L3′ as described below.

For example, the third luminance signal L3 having the third luminance, which is the lowest luminance among the three luminance signals L1, L2, and L3, is defined to have a white luminance signal value LW (i.e., LW=L3), and the three corrected luminance signals L1′, L2′, and L3′ are defined to have corrected luminance that are obtained by subtracting the white luminance signal value LW from the three luminance signals L1, L2, and L3. Accordingly, the first corrected luminance signal L1′ may have luminance that subtracts the third luminance from the first luminance (i.e., L1′=L1−LW), the second corrected luminance signal L2′ may have luminance that subtracts the third luminance from the second luminance, and the third corrected luminance signal L3′ may have luminance that subtracts the third luminance from itself. This results in a luminance value L3′ of 0. This is for the case where the white luminance signal LW is the same as third luminance signal L3.

The second signal ordering unit 914 rearranges the first to third corrected luminance signals L1′, L2′, and L3′ according to color information, and the signals are defined to three color luminance signals LR, LG, and LB of red, green, and blue.

The white de-gamma converter 918 performs de-gamma conversion of the white luminance signal LW to generate a white output image signal W′. For the case described above, where LW is the luminance of the lowest luminance signal L3, de-gamma converter generates an output image signal W′ used by data driver 500 to generate an appropriate voltage level to drive white pixel PW.

The color temperature constant calculator 920 generates red, green, and blue color temperature correcting constants KR, KG, and KB related to each of the red, green, and blue luminance signals LR, LG, and LB based on the white output image signal W′. The color temperature correcting constants KR, KG, and KB are digital signals that display a luminance value and have the same bit length as that of three color luminance signals LR, LG, and LB.

The color temperature correcting constants KR, KG, and KB are constants that produce a target color temperature n2 of the combined white light output of the four pixels PR, PG, PB, and PW, constituting one dot of the display. In other words, when it is intended for one “dot” to display a white color, the color temperature correcting constants KR, KG, and KB correct three color luminance signals LR, LG, and LB so that a color temperature of white light may become a target color temperature n2, where the white light is obtained by summing the light of color pixels PR, PG, and PB and the light of the organic light emitting device LD of the white pixel PW. The color temperature correcting constants KR, KG, and KB have a different value according to a gray of the white output image signal W′, and the value can be obtained experimentally, as they are determined by emission layer materials and manufacturing processes. Without benefit of color temperature correcting constants KR, KG, and KB, the resulting color temperature may be substantially n1, as described above.

The color temperature constant calculator 920 shown in FIG. 5 includes a lookup table 921 and a shift unit 922.

The lookup table 921 may store only a value of the color temperature correcting constants KR, KG, and KB for a limited number of gray among all grays that the white output image signal W′ may have, and for the white output image signal W′ having other grays, the corresponding color temperature correcting constants KR, KG, and KB can be obtained through interpolation.

When the bit length of the input image signals R, G, and B and the output image signals R′, G′, B′, and W′ is smaller than that of three color luminance signals LR, LG, and LB, for example when the input and output image signals R, G, B, R′, G′, B′, and W′ are 8 bit digital signals and the three color luminance signals LR, LG, and LB are 15 bit digital signals, the lookup table 921 can store 15 bit color temperature correcting constants KR, KG, and KB in an address of the 8 bit white output image signal W′.

Alternatively, in order to reduce the size of the lookup table 921, the color temperature correcting constant may be stored with the bit length smaller than the three color luminance signals LR, LG, and LB, and may be adjusted to the bit length of the three color luminance signals LR, LG, and LB through shift calculation of the color temperature correcting constants, and the shift unit 922 can perform the shift calculation. At this time, the shift calculation can be performed by adding a 0 bits to a least significant bit, as needed, to the color temperature correcting constants KR, KG, and KB that are stored in the lookup table 921 until the color temperature correcting constants KR, KG, and KB match the bit length of the luminance image signals LR, LG, and LB.

The color temperature correction unit 915 generates three color corrected luminance signals LR′, LG′, and LB′ by adding color temperature correcting constants KR, KG, and KB from the color temperature constant calculator 920 to the three color luminance signals LR, LG, and LB. At this time, when the bit length of the three color corrected luminance signals LR′, LG′, and LB′ exceeds the limited bit length of de-gamma conversion, the signal processor 910 may further include a bit length adjusting unit 916 that removes least significant bit data that exceeds the bit length from the three color corrected luminance signals LR′, LG′, and LB′.

The three color de-gamma converter 917 receives the red, green, and blue corrected luminance signals LR′, LG′, and LB′ and performs de-gamma conversion of the signals to generate red, green, and blue output image signals R′, G′, and B′. A function used for de-gamma conversion may be different for each color.

The signal processor 910 outputs the three color output image signals R′, G′, and B′ from the three color de-gamma converter 917, and outputs the white output image signal W′ from the white de-gamma converter 918.

Four color output image signals R′, G′, B′, and W′ that are formed with the process can correct a color temperature of white light that four pixels PR, PG, PB, and PW display from a white color temperature n1 to a target white color temperature n2.

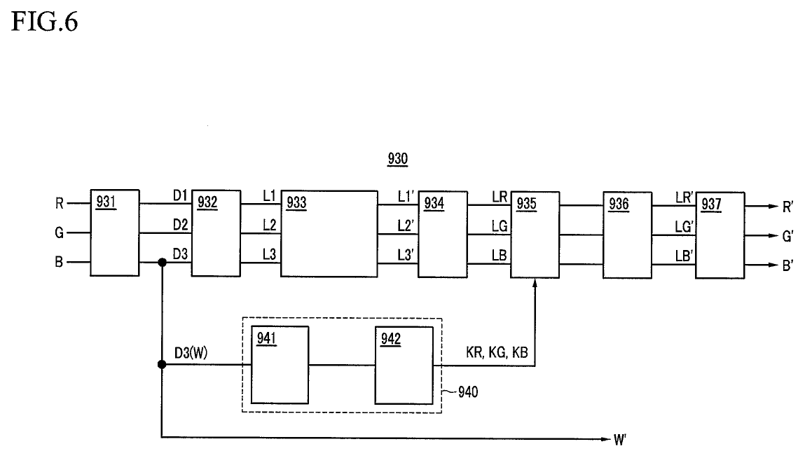

A signal processor 930 according to another exemplary embodiment will be described in detail with reference to FIG. 6.

The signal processor 930 of FIG. 6 includes a first signal ordering unit 931, a gamma converter 932, a calculator 933, a second signal ordering unit 934, a color temperature correction unit 935, a bit length adjusting unit 936, a de-gamma converter 937, and a color temperature constant calculator 940, similar to that of the signal processor 910 of FIG. 5. The color temperature constant calculator 940 includes a lookup table 941 and a shift unit 942.

However, the signal processor 930 of FIG. 6 does not include the white de-gamma converter of FIG. 5. First signal ordering unit 931 orders input signals R, G and B in order from largest gray level signal D1, then signal D2, to smallest signal D3. First signal ordering unit 931 supplies the third signal D3, i.e., the one that is the smallest among signals D1, D2, and D3, as the white output image signal W′ to the color temperature constant calculator 940. First signal ordering unit 931 also outputs the signal W′ to the outside.

According to the signal processor 930 of FIG. 6, an operation can be simplified by omitting de-gamma conversion for generating the white output image signal W′.

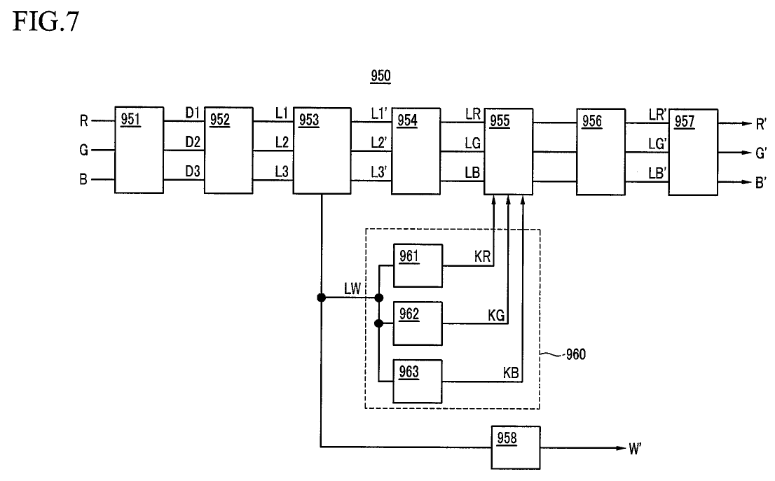

FIG. 7 is a block diagram of a signal processor 950 according to still another exemplary embodiment. The signal processor 950 of FIG. 7 includes a first signal ordering unit 951, a gamma converter 952, a calculator 953, a second signal ordering unit 954, a color temperature correction unit 955, a three-color de-gamma converter 956, a white de-gamma converter 958, and a color temperature constant calculator 960, similar to the signal processor 910 of FIG. 5.

However, the color temperature constant calculator 960 shown in FIG. 7 includes three multipliers 961, 962, and 963.

At least one color temperature correcting constants KR, KG, and KB may be a linear function of the white luminance signal LW, and this linear function may have a different slope according to color R, G or B, i.e., KR=K_{R}*LW, KG=K_{G}*LW, and KB=K_{B}*LW, where K_{R} is the slope of the dependence of KR on LW, with similar slopes K_{G} and K_{B} for KG and KB, respectively.

When such linearity is satisfied between the color temperature correcting constants KR, KG, and KB and the white luminance signal LW, the color temperature correcting constants KR, KG, and KB for each color can be simply obtained with the multipliers 961, 962, and 963 shown in FIG. 7. For example, each of the multipliers 961, 962, and 963 generates the color temperature correcting constants KR, KG, and KB of each color by multiplying the white luminance signal LW by a coefficient KR, KG or KB corresponding to the slope of that color.

By selecting a linear slope for each color temperature correcting constant KR, KG, and KB dependence on LW, a target white color temperature n2 can be adjusted and a white color temperature that may change according to a gray level of the white color output image signal W′ can be adjusted to the target white color temperature n2.

According to an exemplary embodiment, a color temperature of white color light that four color pixels display may be adjusted to a target color temperature by adjusting an image signal value related to the remaining three color pixels according to luminance of white light that a white pixel emits.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a plurality of pixels, wherein each pixel comprises a first color pixel, a second color pixel, a third color pixel, and a white color pixel;
a signal processor configured to generate a white color output image signal based on a first, a second, and a third color input image signal, generate a white color temperature correcting constant based on the white color output image signal, and generate first color, second color, and third color output image signals that correct the first, second, and third color input image signals based on the white color temperature correcting constant; and
a data driver configured to convert the output image signals to a plurality of data voltages and supply the data voltages to the respective plurality of pixels for displaying an image.

2. The display device of claim 1, wherein the white color temperature correcting constant has a value such that white light that is generated by combining the first, second, and third color pixels and the white color pixel satisfies a target white color temperature.

3. The display device of claim 2, wherein the white color temperature correcting constant has a different value depending on a gray level of the white color output image signal.

4. The display device of claim 3, wherein the white color temperature correcting constant separately has a value corresponding to the first color, the second color, and the third color.

5. The display device of claim 4, wherein the white color temperature correcting constant is determined in luminance space.

6. The display device of claim 5, wherein the signal processor generates first color, second color, and third color luminance signals by performing gamma conversion of each of the first color, second color, and third color input image signals, generates first color, second color, and third color corrected luminance signals by calculating each of the first color, second color, and third color luminance signals using the white color temperature correcting constant, and generates the first, second, and third color output image signals by performing de-gamma conversion of the first color, second color, and third color corrected luminance signals.

7. The display device of claim 6, wherein the signal processor generates a white luminance signal from the first, second, and third color luminance signals and generates the white color output image signal by performing de-gamma conversion of the white luminance signal.

8. The display device of claim 7, wherein the white luminance signal is equal to a smallest luminance signal among the first, second, and third color luminance signals, and
the first, second, and third color corrected luminance signals are obtained by subtracting the white luminance signal from the first, second, and third color luminance signals and then calculating the corrected luminance signals with the white color temperature correcting constant.

9. The display device of claim 6, wherein the white output image signal is equal to a smallest input image signal among the first, second, and third color input image signals.

10. The display device of claim 6, wherein the signal processor includes a lookup table that stores a white color temperature correcting constant of the first, second, and third colors as a function of a gray that the white output image signal has.

11. The display device of claim 10, wherein the signal processor performs a shift calculation so that a bit length of the white color temperature correcting constant of the first, second, and third colors that are stored in the lookup table is equal to that of the luminance signals.

12. The display device of claim 8, wherein the white color temperature correcting constant is a linear function of a luminance of the white color output image signal.

13. The display device of claim 12, wherein the signal processor obtains the white color temperature correcting constant of the first, second, and third colors by multiplying luminance of the white color output image signal by a different coefficient.

14. The display device of claim 11 or 13, wherein the signal processor performs de-gamma conversion by adjusting the bit length of the corrected luminance signal to a predetermined bit length.

15. The display device of claim 14, wherein the first, second, and third colors are three primary colors.

16. The display device of claim 15, wherein each pixel includes an organic light emitting device.

17. A driving method of a display device, comprising:
receiving three input image signals that represent each of three primary colors;
generating three luminance signals and a white output image signal based on the three input image signals;
generating three white color temperature constants based on the white output image signal;
generating three corrected luminance signals by calculating each luminance signal with the white color temperature correcting constant; and
generating three output image signals by performing de-gamma conversion of the three corrected luminance signals.

18. The driving method of claim 17, further comprising
converting each of the three output image signals and the white output image signal to a data voltage and applying the data voltage to each of four corresponding pixels of the display device,
wherein a white color that the four pixels display satisfies a target white color temperature when the three input image signals display a white color.

19. The driving method of claim 18, wherein the white color temperature correcting constants have different magnitudes depending on the white color output image signal.
